(19) United States
(12) Patent Application Publication
(10) Pub. No.: US 2007/0035812 A1
(43) Pub. Date: Feb. 15, 2007

(54) Godly Powers

(75) Inventor: Christopher Anthony Roller, Burnsville, MN (US)

Correspondence Address: Mr. Christopher Anthony Roller, 13150 Harriet Ave S #273, Burnsville, MN, 55337, US

(73) Assignee: Christopher Anthony Roller, Burnsville, MN (US)

(21) Appl. No.: 11/161,345

(22) Filed: Jul. 29, 2005

(51) Int. Cl. H01S 3/00

(52) U.S. Cl. 359/337.1

(57) ABSTRACT

Christopher Anthony Roller is a godly entity. “Granters” had been given my powers (acquired my powers) (via God probably). These “granters” have been receiving financial gain from godly powers. These “granters” may be using their powers without morals. Chris Roller wants exclusive right to the ethical use and financial gain in the use of godly powers on planet Earth. The design of godly-products have no constraints, just like any other invention, but the ethnic consideration of it's use will likely be based on a majority vote of a group, similar to law creation. The commission I require could range from 0-100% of product price, depending on the product's value and use.

Christopher Anthony Roller wants exclusive right to the ethical use and financial gain in the use of godly powers on planet Earth.

### DESCRIPTION

Christopher Anthony Roller wants exclusive right to the ethical use and financial gain in the use of godly powers on planet Earth.

What is claimed is:

1. Godly powers are being used on planet Earth. For example, technology (i.e. Electronic and Medical) is being assisted by godly powers throughout the planet.
Godly powers could be used prior, during, and after godly product/procedure. For example;
Before—in the making of a device, like a micro-processor chip.
During—in the operation of a device, like an inkjet printer cartridge.
Afterwards—like gradual scar removal from breast implant surgery.
A magician might perform magic before, during, and after, for any given trick (“illusion”).

2. There is a plan governing our existence and actions—God's plan.

3. Christopher Anthony Roller is the godly entity powering Earth with godly powers as stated in claim 1.

4. From claim 2, God's plan (or Game of Life) puts restrictions on what can currently be done with godly powers, or even if/when.

5. From claims 2 and 4, there are restrictions on what magic (godly powers) can be in Chris Roller's presence—what Chris Roller can actually witness, which can differ from what everyone else can witness (in claim 4). Also, the magic needs to have a plausible explanation for its end product, like magicians calling their magic “illusions” or “tricks”.

6. From claim 1, godly powers can be transferred once a grantor—a grantee. A grantee can be a grantor only if granted the right, and only a subset of the rights a grantor possesses.

7. From claim 1 and 6, some grantees may be using their powers without morals.

8. Claim 1 is proved via David Copperfield, who has been using godly powers for his financial gain (MN Federal case 05-446JRT/FLN) and hiding knowledge of godly powers as stated in claim 7.

9. From claim 1, there are many phenomenons associated with godly powers—most of them discussed on www.mytrumanshow.com.

10. From claims 5 and 9, anything Chris Roller finds out is fact (information from all senses except psychic/imagination—i.e. global information via television from eyes and ears) becomes a state of reality on planet Earth.

11. In association with claims 7 and 9, will-power can be cast on another to control people's fate.

12. From claims 2, 5, and 9, reality can be restructured. Chris sometimes calls this re-ravel. Magic completely countered/reversed is called unravel.

13. From claim 12, information via psychic/imagination (not real yet) (non-eyes/ears) can be reversed/re-raveled/unraveled.

14. From claim 12, 5, and 10, unravel/re-ravel can only be done before Chris Roller gets the “real” news, and almost entirely governed by God's plan as stated in claim 2.

15. Immoral activity from claim 7 can be covered up with reality restructuring mentioned in claim 12.
